(19) United States
(12) Patent Application Publication
(10) Pub. No.: US 2026/0339994 A1
(43) Pub. Date: Oct. 29, 2026

(54) MOE ARCHITECTURE-APPLIED LANGUAGE MODEL-BASED QNA SYSTEM FOR MANUFACTURING SITE

(71) Applicant: MISOINFO Tech., Seoul (KR)

(72) Inventors: Dong-wook AN, Seoul (KR); Sang-do NAM, Seoul (KR); Jin-ho SON, Hanam-si (KR); Kwang-jae WON, Suwon-si (KR); Moon-young PARK, Goyang-si (KR)

(21) Appl. No.: 19/422,981

(22) Filed: Dec. 17, 2025

(30) Foreign Application Priority Data
Apr. 29, 2025 (KR) 10-2025-0056303

(51) Int. Cl. G06F 16/3329; G06N 3/045; G06Q 50/04

(52) U.S. Cl. CPC G06F 16/33295; G06N 3/045; G06Q 50/04

(57) ABSTRACT

One aspect of the present disclosure relates to a question-and-answer system used in manufacturing sites, and more particularly, to a language model question-and-answer system based on a mixture of experts (MoE) architecture to analyze various manufacturing site data, such as manufacturing process, production facilities, and delivery schedule, in real time, and provide natural language-based answers corresponding to queries of workers.

### CROSS REFERENCE TO RELATED APPLICATION

The present application claims s priority to Korean Patent Application No. 10-2025-0056303, filed on Apr. 29, 2025, the entire contents of which is incorporated herein for all purposes by this reference.

### BACKGROUND OF THE INVENTION

### 1. Field of the Invention

One aspect of the present disclosure relates to a question-and-answer system used in manufacturing sites, and more particularly, to a language model question-and-answer system based on a mixture of experts (MoE) architecture to analyze various manufacturing site data, such as manufacturing process, production facilities, and delivery schedule, in real time, and provide natural language-based answers corresponding to questions of workers.

### 2. Description of the Related Art

Manufacturing industrial sites are complexly intertwined with various facilities and processes, and accordingly have characteristics in which various pieces of information, such as production schedules, quality controls, safety rules and equipment manuals, are required to be managed simultaneously and integrally.

The above information exists distributed across a plurality of systems, such as ERP, MES and RDBMS, and site workers or managers require significant time and effort for inquiring in time about necessary information and performing corresponding responses.

Search systems using standardized user interfaces (UIs), predefined scenario-based chatbot systems, general language model-based answering systems or the like have been used as a means for a search or response about the above information, however, these systems fail to fully satisfy actual needs of manufacturing sites.

General static screen-based systems have difficulty in responding flexibly depending on the type of query, and have limitations in quickly figuring out information wanted by workers. In addition, some voice assistants or chatbot systems only provide static answers at the level of simple FAQs and may often fail to provide adequate information for inquiries requiring expertise, for example, sophisticated inquiries about such as equipment failure diagnosis or safety-related measures.

Recently, natural language answering systems based on large language models have been spotlighted. However, when only a general language model is applied without domain specialization, specialized knowledge in the manufacturing field is not reflected, and accordingly, the answer may have low accuracy and it may be difficult to ensure on-site reliability.

Particularly, the existing systems rely on inadequate expert selection rules or operate based on static selection weights, and accordingly, have an insufficient function of self-optimizing or evolving according to actual user feedback or changes in usage context.

This structure may cause limitations in the practical use of information in manufacturing environments in which various types of inquiries arise depending on the field situation and corresponding professional answers are required, users may experience reduced work efficiency due to repetitive queries and incomplete answers, and sometimes even delays may arise in safety-related decisions.

Accordingly, there is the emerging need for an intelligent question-and-answer system having a self-optimizing structure to link data and systems specialized in the manufacturing domain (comprehensively covering entire manufacturing sites and business areas), combine various experts for real-time queries to generate answers, and further, dynamically adjust expert selection weights by reflecting user feedback, usage frequency and the like.

### Document of Related Art

### Patent Document

(Patent Document 1) Korean Patent Registration No. 10-2747473 (registered on Dec. 23, 2024) “MANUFACTURING FACILITY CONTROL METHOD THROUGH SPEAKER VERIFICATION”

### National Research and Development Project for Supporting Present Disclosure

| | |
|---|---|
| Project Unique Number | 2410005274 |
| Project Number | 00470349 |
| Implementing Ministry Name | Ministry of Trade, Industry and Energy |
| Research Management | Korea Planning & Evaluation |
| Specialist Institution | Institute of Industrial |
| (Institutionconcluding | Technology |
| business agreement with | |
| managing institution) | |
| Research Business Name | Electronic Components Industry |
| | Technology Development (R&D) |
| Research Project Name | Development And Demonstration |
| | Of On-device AI Technology To |
| | Support Worker Convenience And |
| | Personalization Based On |
| | Domestically Produced Socs |
| | Targeting The Electronics |
| | Components Industry |
| Managing Institution | BI MATRIX Co., Ltd. |
| Research Period | 2024 Sep. 1-2027 May 31 |

### SUMMARY OF THE INVENTION

An object of the aspect of the present disclosure is to provide a language model-based question-and-answer system capable of answering in real time to various questions through a arising in manufacturing sites plurality of experts linked to manufacturing data, dynamically adjust weights after reflecting user feedback or selection frequency for selecting the experts, thereby overcoming the limitations of existing systems operating subject to fixed selection rules, and further, improve answering accuracy and user experience through a gating network structure capable of self-optimizing based on mathematical computations.

In order to achieve the above object, the aspect of the present disclosure provides an MoE architecture-applied language model-based question-and-answer system for a manufacturing site, which includes a user terminal serving as a terminal of a worker in a manufacturing site, a main server including a central processing unit, and a network for relaying the user terminal and the main server, wherein the user terminal includes: an input unit for receiving a query and user feedback in a voice or text form from a user; and an output unit for outputting an answer to the user, and the main server includes: an MoE architecture including an expert module composed of a plurality of experts, and a gating network for selecting one of the experts based on a type of the query; a language model processing unit for analyzing the received query and generating a natural language-based answer through the expert selected by the gating network; a database for storing manufacturing facility-related information, query history, and user feedback data; and a memory device for storing commands and learning parameters for operations of the gating network and the language model processing unit.

In addition, the system further includes: a learning unit for retraining the language model processing unit based on the user feedback received from the user terminal.

In addition, the expert module includes a retrieval-augmented generation (RAG)-based document search-type expert, a manufacturing facility DB query-based monitoring expert, a scenario response expert, and a general query expert.

Further, the aspect of the present disclosure provides Equations for selecting experts through the gating network.

According to the aspect of the present disclosure, experts linked with data specialized in the manufacturing domain can be selected for inquiries arising in the manufacturing site and real-time answers can be provided based on a natural language, so that information accessibility can be improved. In addition, the weights of experts can be dynamically adjusted based on user feedback or selection frequency, so as to implement the system having a self-learning structure that optimizes itself, so that efficiency and accuracy in the manufacturing site can be improved.

### BRIEF DESCRIPTION OF THE DRAWINGS

FIG. 1 is a conceptual diagram schematically showing a system of the aspect of the present disclosure.

FIG. 2 is a conceptual diagram showing a schematic configuration of the system of the aspect of the present disclosure.

FIG. 3 is a conceptual diagram schematically showing a system flow of the aspect of the present disclosure.

### DETAILED DESCRIPTION OF THE INVENTION

Hereinafter, various embodiments and/or aspects will be described with reference to the accompanying drawings. In the following description, a plurality of specific details are set forth to provide comprehensive understanding of one or more aspects for the purpose of explanation. However, it will also be appreciated by a person having ordinary skill in the art that such aspect(s) may be carried out without the specific details. The following description and accompanying drawings will be set forth in detail for specific exemplary aspects among one or more aspects. However, these aspects are illustrative and some of various methods in the principles of the various aspects may be utilized, and the descriptions are intended to include all such aspects and their equivalents. Specifically, the terms “embodiment”, “example”, “aspect” or the like used herein may not be construed in that an aspect or design set forth herein is preferable or advantageous than other aspects or designs.

Hereinafter, identical or similar components may be given the same reference numerals regardless of different drawings and duplicate descriptions thereof will be omitted. Further, in the following description of the embodiments disclosed in the present specification, a detailed description of a related known technology incorporated herein will be omitted when it possibly makes the subject matter of the embodiments disclosed in the present specification unclear. In addition, the accompanying drawings are only intended to facilitate understanding of the embodiments disclosed in the present specification, and the technical ideas disclosed in the present specification are not limited by the accompanying drawings.

Although the terms first, second and the like are used to describe various elements or components, these elements or components are not limited by the above terms. The above terms are merely used to distinguish one element or component from another. Accordingly, the first element or component mentioned below may also refer to a second element or component within the technical idea of the aspect of the present disclosure.

Unless otherwise defined, all terms (including technical and scientific terms) used herein may be used in a meaning that can be commonly understood by a person having ordinary skill in the art to which the aspect of the present disclosure belongs. In addition, terms defined in generally used dictionaries are not ideally or excessively interpreted unless explicitly defined otherwise.

Further, the term “or” is intended to signify an inclusive “or” rather than an exclusive “or”. In other words, unless otherwise specified or clear from context, the expression “X uses A or B” is intended to signify one of natural inclusive substitutions. In other words, when X uses A; X uses B; or X uses both A and B, then the expression “X uses A or B” may be applied to either of the above cases. In addition, it is apparent to be understood that the term “and/or” as used herein refers to and includes all possible combinations of one or more among related items listed.

In addition, it will be understood that the terms “include” and/or “including” imply the presence of the corresponding features and/or components, but do not preclude the presence or addition of one or more other features, components and/or groups thereof. In addition, unless otherwise specified or clear from the context to refer to a singular form, the singular form in the present specification and claims may generally be construed to signify “one or more.”

Further, the terms “information” and “data” used herein are often used interchangeably.

When one component is recited to be “connected” or “linked” to other component, it will be understood that the one component may be directly connected to or linked to the other component, but another component may be present therebetween. On the contrary, when one component is recited to be “directly connected” or “directly linked” to other component, it will be understood that another component is not present therebetween.

The suffix such as “module” and “unit” for components used in the following description is given or mixed merely to facilitate description of the specification, and the suffix itself is not intended to give any meaning or function to differentiate the components with each other.

The purposes and advantageous effects of the present disclosure and the technical configurations for achieving the purposes and the advantageous effects will be apparent with reference to the embodiments described in detail below together with the accompanying drawings. In the following description of the present disclosure, the detailed description of known functions and configurations incorporated herein will be omitted when it possibly makes the subject matter of the present disclosure unclear unnecessarily. Further, the terms described later are terms defined in consideration of functions in the present disclosure, which may vary according to a user's or operator's intention or practice.

However, the present disclosure is not limited to the embodiments described as below and may be implemented in various different forms. The embodiments are provided to complete the present disclosure and clearly teach the scope of the disclosure to a person having ordinary skill in the art, and the present disclosure will be defined only by the scope of claims. Therefore, the above definition will be made based on the contents throughout the present specification herein.

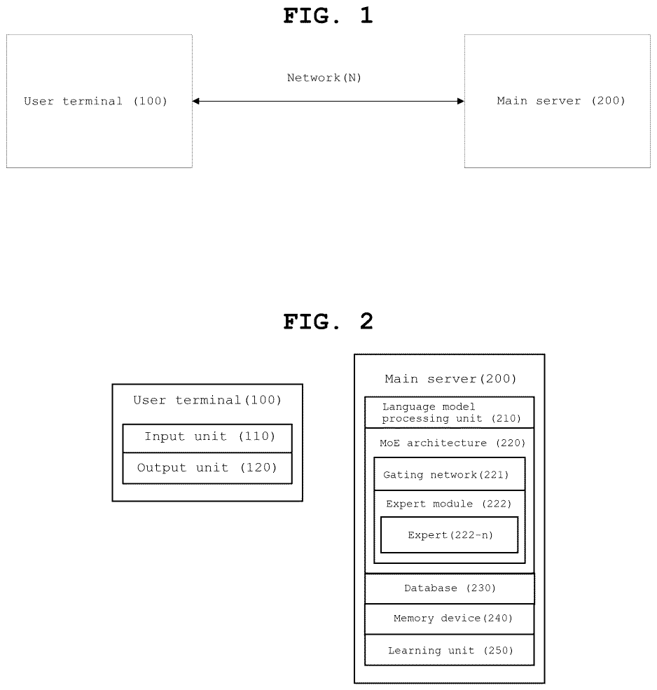

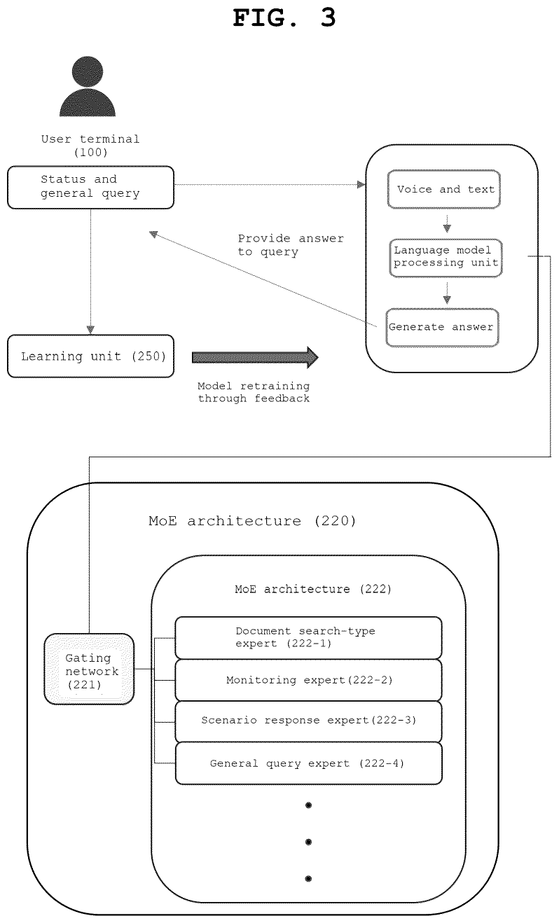

FIG. 1 is a conceptual diagram schematically showing a system of the aspect of the present disclosure.

Referring to FIG. 1, the system may be implemented including a user terminal 100, a network N, and a main server 200.

However, the above components are not limited to the essential configuration, and depending on implementation environments, more components may be included or some may be integrated and implemented as a single device.

The user terminal 100 refers to a device directly carried and used by the user, and includes an interface for transmitting queries to the system through voice or text input and receiving answers from the system in the form of output. The user terminal 100 may include various types of wired and wireless network connection devices such as personal computers (PCs), tablets, smartphones, industrial human machine interface (HMI) devices, wearable devices, and smart kiosks, and the input and output interface may include a touchscreen, a microphone, a keypad, a voice recognition module, a speaker, a display device, and the like.

Particularly, the input and output interface of the user terminal 100) of the aspect of the present disclosure may be defined as an input unit 110 for receiving a question in the form of voice or text from a worker and an output unit 120 for outputting an answer to the user.

Specifically, the input unit 110 may be implemented with various sensing devices such as a microphone, a keypad, a touch screen, a handwriting recognition device, a voice recognition sensor, or a camera-based character recognition device, may switch an operation mode depending on the form of the user's input, and may be configured to automatically activate the microphone and the voice recognition software, for example, when the worker directly questions by voice without pressing a button.

The output unit 120 may include a display device, a speaker, a vibration feedback module, an LED visual display device, or the like, may be designed to differently operate depending on the type of response (such as text, voice, or alert), may provide a natural language answer received from the main server 200 to the worker in the visual or auditory form, and may display a message on a display of the terminal or provide a voice guidance via a voice synthesizer depending on the nature of the answer. In addition, in the case of answer containing a predetermined level of warning or caution, the output unit 120 may be configured to provide multi-modal feedback together in various forms, such as vibration, flashing, and changes in color.

The user terminal 100 includes a central processing unit and a storage medium to perform the functions of the input unit 110 and the output unit 120, and generates the query request and then transmits corresponding query information to the main server 200 via the network N.

The network N may be implemented as a communication mechanism including both wired and wireless, and for example, may include various communication networks or protocols such as public network-based Internet, private network-based industrial Ethernet, LTE/5G wireless communication networks, Wi-Fi, Bluetooth, Zigbee, Ultra Wide Band (UWB), or near field communication (NFC). In other words, the network N connects the user terminal 100 and the main server 200 to enable two-way data transmission in between.

the main server 200 of the aspect of the present disclosure refers to a central computing device that performs the function of receiving a manufacturing site query entered through the user terminal 100, selecting one or more appropriate experts from among a plurality of experts depending nature of the query, and generating and returning a response. The main server 200 may be implemented as a hardware system in which a communication mechanism, a central processing unit, a memory device, a storage mechanism, and various execution modules are installed to perform the above functions.

In other words, the main server 200 may be configured as a computing hardware device including a central processing unit (CPU) and/or a graphics processing unit (GPU), a storage media such as volatile memory (RAM), non-volatile memory (ROM), hard disk drive (HDD) and solid state drive (SSD), and a wired and wireless communication module (for example, LAN port, Wi-Fi module, 5G/NR modem, Bluetooth transceiver and the like). In addition, the main server 200 of the aspect of the present disclosure may be implemented as a single device, configured as a cluster-based multiple devices, or driven on a cloud server infrastructure or edge computing environment.

In other words, according to some embodiments of the aspect of the present disclosure, the user terminal 100 and the main server 200 may be integrated into one industrial controller device, and the network N may be configured as a hybrid structure linked to a manufacturing facility's internal network or cloud infrastructure. In addition, the main server may have a major configuration implemented as a plurality of logical servers or a container-based micro-service structure other than a single physical server, so as to enhance scalability and maintainability of the system.

Various software programs for implementing the language model processing function and the expert selection function of the aspect of the present disclosure are installed and executed on the main server 200. These programs are installed in the storage mechanism of the system and executed through the central processing unit. The programs may be configured in the form of ‘modules’, ‘units’ or ‘interfaces’ divided by function, and will be described for each functional component in detail in the present specification.

In addition, the main server 200 may be implemented based on a System on Chip (SoC) structure. In this case, a central processing unit, a graphics processing unit, a memory controller, an input/output interface and the like may be provided in an integrated form within a single chip. This configuration is suitable not only for large server environments requiring high-performance computing, but also for edge computing environments in manufacturing sites in which space efficiency and low power consumption are important.

The storage mechanism of the main server 200 may include both of a volatile memory and a non-volatile memory, which include a memory device 240 for storing execution-related commands and learning parameters, and a database 230 for storing manufacturing facility-related information, inquiry history, and user feedback data.

Various data including command sets, model parameters, user feedback information, and query processing history is stored therein. In addition, program instructions for execution of each ‘unit’ or ‘module’ described later are stored and executed in the storage mechanism.

The memory device 240 may be implemented as a memory device such as RAM or ROM, the database 230 may be configured as a relational (RDB), non-relational (NOSQL) system, an externally linked cloud DB or the like, and the memory device 240 and the database 210, depending on the implementation environment, may be implemented logically separated within a single storage device, or may be configured as physically separate independent devices or servers.

The software programs stored in the storage media may be implemented in various programming languages such as C, C++, Python, Java, or other scripting languages, and may operate after being compiled or interpreted in the form of data structures, algorithms, functions, object-oriented classes, tasks, procedures, subroutines, or drivers. These configurations may be software applications operating on an operating system, or may be code executed directly by hardware-implemented FPGAS, ASICs, or DSPs.

Each ‘unit’ or ‘module’ included in the main server 200 may be a unit of program code, or may be implemented as a data table, variable array, algorithm set, or multiple hardware circuits. In addition, these components may be integrated into a single function or may be implemented as more segmented multiple subcomponents such as ‘interfaces’.

Particularly, the main server 200 of the aspect of the present disclosure is configured to analyze questions and generate answers, and includes a mixture of experts (MoE) architecture 220.

The MoE architecture refers to a structure that configures multiple expert models in parallel and selects the most appropriate expert for a given query. This may overcome the limitations of the existing structure in which a single model processes all queries, and flexibly select specialized experts according to the characteristics of the query, so that response accuracy and processing efficiency can be improved.

Hereinafter, the MoE architecture-applied language model-based question-and-answer system for a manufacturing site according to the aspect of the present disclosure will be described in detail.

The system of the aspect of the present disclosure starts operations of the system at the moment of the worker's inquiry, and has a structure that follows a series of flows, such as query input through the user terminal, query analysis and branch processing, expert-based response generation, and output of the generated response.

As mentioned above, the user terminal 100 includes the input unit 110 for receiving queries from the worker. The input unit 110 performs the function of recognizing a query in voice or text form and transmitting the recognized query as a format suitable for system processing.

The user query may be voice or text input, such as, for example, “Tell me the operating rate of line 2 equipment” or “Show me the morning quality inspection results”.

The query entered through the input unit 110 is converted into digital data within the user terminal 100. The query data processed in the above manner is transmitted to the main server 200 via the network N.

The main server 200 includes a language model processing unit 210, an MoE architecture 220, a database 230, and a memory device 240, and performs a query data processing procedure described later.

The database 230 refers to a repository for stores various information referenced by each component of the main server 200, and may include manufacturing facility-related information, user query history and user feedback data, document data, and scenario manuals.

The manufacturing facility-related information includes the facility's operating history, failure records, maintenance and repair schedules, and the like, the user query history refers to previous records of queries entered by the user and corresponding system response records, and the user feedback data includes the user's evaluations or additional inputs regarding appropriateness of the response or the like.

The above pieces of information are referenced when each expert 222-n of the expert module 222 in the main server 200 generates a response to a query, and also used in the operations of the language model processing unit 210 and the MoE architecture 220. This will be described later.

The memory device 240 refers to a repository that stores commands and pre-trained model parameters required for operations of the main function modules in the main server 200. More particularly, the memory device 240 stores and provides information required for controlling and optimizing internal operations of the system, such as weight calculation logic for operating a gating network 221, condition setting for selecting experts, and sentence analysis parameters of the language model processing unit 210.

For example, the weight update computation formula to be performed in the gating network 221, the selection history-based feedback-applied logic, and the threshold value for the response generation criterion are initialized based on the information stored in the memory device 240, updated while the system is running, and reflected in the subsequent query processing flow.

Both of the databases 230 and the memory device 240 are configured to store information in the main server 200, but each has a different role.

Specifically, the database 230 focuses on storing information related primarily to the external world, such as “query history, facility data, documents, manuals” collected or generated through users or interfaces with external systems, whereas the memory device 240 focuses on storing “commands, parameters, setting values, and the like” for performing the internal logic of the system to support the operation and learning of the main server 200 itself.

Through the above distinction between the database 230 and the memory device 240, the system of the aspect of the present disclosure can separately optimize the external information management and the internal algorithm control, and simultaneously achieve high scalability and stability.

Meanwhile, the query data received through the network N is analyzed and structured into natural language meaning units by using the language model processing unit 210 in the main server 200, and the results generated through the above process may be defined as query analysis data.

Specifically, the language model processing unit 210 serves to extract core keywords from the query and analyze the relationship therebetween to identify the intent and entity of the query. The above natural language processing function is based on a pre-trained large language model (LLM), and may have been additionally trained (fine-tuned) to effectively process manufacturing-specific terminologies, abbreviations and sentence patterns.

The query analysis data, when, for example, the query “Tell me the operating rate of Line 2 equipment of today morning” is entered, may extract core keywords such as [Line 2], [equipment], [today], [operating rate] and [morning] via the query analysis data, and the relationship between the keywords may be used to determine that the query is a request to retrieve equipment data at a specific time point with low volatility.

The above query analysis data is transmitted to the MoE architecture 220. The MoE architecture 220 includes a gating network 221 and an expert module 222, and the gating network 221 functions to select one or more experts among a plurality of experts 222-n within the expert module 222 based on the entered query analysis data.

The experts 222-n constituting the expert module 222 includes a retrieval-augmented generation (RAG)-based document search-type expert 222-1, a manufacturing facility DB query-based monitoring expert 222-2, a scenario response expert 222-3, and a general query expert 222-4.

The document search-type expert 222-1 refers to is a module that operates based on retrieval-augmented generation (RAG), and generates responses to query analysis data with respect to information having low volatility, such as equipment information, guide documents, and ordering party-related information stored in the database 230.

The information having low volatility refers to data that changes little over time, such as equipment specifications, standard operating procedures, and manufacturing process-specific fixed instructions.

In order to quickly and accurately retrieve the fixed type information, the document search-type expert 222-1 segments text, image and document data stored in the database 230 by using the chunking technique, converts the segmented data into vector form, and stores and manages the converted data in a separate vector database (Vector DB).

For example, when the query analysis data “Tell me the operating rate of Line 2 equipment of today morning” is entered, the document search-type expert 222-1 may search for related chunks from the vector database based on key keywords such as [Line 2], [equipment], [today], [operating rate] and [morning], find the standard operating guideline for “How to inquire the morning operating rate of Line 2 equipment” and provide materials for generating responses.

In this process, the document search-type expert 222-1 may be designed to perform vectorized semantic similarity analysis, rather than simply matching keywords, to extract the document content most semantically close to the query.

The monitoring expert 222-2 refers to a module for monitoring operational data such as manufacturing site equipment, production and quality, in real time and generating responses to real-time information inquiries based on query analysis data, and handles information such as the operating status, production volume, and quality indicators of manufacturing equipment highly volatile and fluctuated moment by moment.

The monitoring expert 222-2 searches for real-time data stored in various systems such as ERP, MES and RDBMS from an integrated database (integrated DB) linked to the database 230.

To this end, a text-to-query conversion function for automatically generating SQL queries from the query analysis data is included.

For example, when the query analysis data “Tell me the operating rate of Line 2 equipment of today morning” is entered, the monitoring expert 222-2 may automatically generate the SQL query suitable for corresponding conditions based on the core keywords [Line 2], [equipment], [today], [operating rate], and [morning], and transmit the query to the ERP or MES database, thereby generating real-time answers such as “The operating rate of Line 2 equipment from 9:00 to 12:00 is 85%”.

In addition, the monitoring expert 222-2 may process the collected real-time data into visualization and dashboard format, so as to expand additional monitoring services such as directly displaying the operating rate on the manufacturing equipment in addition to the transmission to the user terminal 100.

The scenario response expert 222-3 refers to a module for generating responses corresponding to the query analysis data based on various predefined situational response scenarios, and provides rapid and consistent response guides based on pre-written response manuals, regulatory procedures, checklists and the like, with respect to specific situations or incidents occurring repeatedly in manufacturing sites (for example, equipment failure, quality abnormalities, emergency production instructions, and the like).

The scenario response expert 222-3 operates with reference to the scenario manual stored in the database 230.

The scenario manual may be composed of response measures by accident type, inspection procedures upon quality issues, response protocols for emergency production modification instructions, and the like.

For example, when the query analysis data “Tell me what to take action upon error occurring on line equipment” is entered, the scenario response expert 222-3 may search for predefined equipment error response scenarios in the database 230 based on the keywords [Line 2], [equipment], [error occurring] and [take action], and generate specific and stepwise responses such as “Step 1: Power off the equipment, Step 2: Check the abnormal sites, Step 3: Report to the manager and maintenance team”.

Further, the scenario response expert 222-3 may also be designed to provide additional step-by-step detailed guidance even when the user requests detailed procedures through additional inquiries.

The general query expert 222-4 refers to a module for generating responses to general information requests or simple queries that do not require specific document searching, manufacturing facility monitoring, or scenario matching, and is primarily designed to respond to queries, such as general knowledge related to manufacturing sites, work procedures, basic regulations guidance, and simple numerical information, which can be processed without relying on specific databases or scenarios.

For example, when the user enters a query such as “What is the defect rate threshold?” or “Tell me the work shift times”, keywords such as [defect rate], [threshold], [work] and [shift times] may be extracted from the query analysis data, and general regulation data or internal standard data in the database 230 may be referred so as to generate responses such as “The defect rate threshold is 1% or less.” or “Shift times are 7:00 AM, 3:00 PM, and 11:00 PM”.

The general query expert 222-4 has the feature of quickly returning responses without additional data retrieval or complex calculations by utilizing a pre-trained standard response set or basic knowledge base.

The gating network 221 performs weighting calculations for each expert in order to select one expert among the experts 222-n within the expert module 222 based on the query analysis data.

First, the gating network 221 in an initial stage starts with the same initial weight (for example,

$${w}_{i}^{( 0 )} = 0.25 )$$

assigned to all of the experts 222-n.

Thereafter, based on the user's actual usage pattern or feedback results, the weights are periodically updated after reflecting the relative selection frequency or response suitability of each expert. The update scheme is as follows:

The gating network 221 calculates a provisional weight

$$( \text{?} )$$

$$\text{?} \text{indicates text missing or illegible when filed}$$

according to the following Equation 1, at a specific time point t, for each expert, based on a current weight

$$( {w}_{i}^{( t )} )$$

and a user reflection coefficient

$$( {r}_{i}^{( t )} ) .$$

$${w}_{i} = \text{?} \cdot \text{?} \qquad [ Equation 1 ]$$

$$\text{?} \text{indicates text missing or illegible when filed}$$

Thereafter, the calculated provisional weights are normalized according to the following Equation 2, thereby determining final weights

$$( {w}_{i}^{( t + 1 )} ) .$$

$${w}_{i}^{( t + 1 )} = \frac{{\hat{w}}_{i}^{( t + 1 )}}{{\sum }_{j = 1}^{k} {\hat{w}}_{i}^{( t + 1 )}} \qquad [ Equation 2 ]$$

Herein, subscript i denotes an index to identify a specific exp

$${\sum }_{j = 1}^{k} \text{?} ,$$

$$\text{?} \text{indicates text missing or illegible when filed}$$

t denotes a time interval for weight update, and denotes a sum of weights for all present experts from 1 to k.

In the above manner, the weight of each expert is dynamically adjusted based on the user's actual query processing results.

For example, after setting the initial weights of four experts (222-1 to 222-4) to 0.25, respectively, the expert-specific usage statistics collected for the keyword [operating rate] over a predetermined period of time may be assumed as follows:

$${r}_{1 - 4}^{( t )} = ( 89 , 71 , 54 , 32 )$$

When the document search-type expert 222-1 is set as the representative and the calculation reference time point is set from the start of the system to the present, it is calculated as

$${\hat{w}}_{1}^{( t + 1 )} = 0.25 \cdot 89 = 22.25$$

subject to Equation 1, and accordingly, total provisional weights are calculated as

$${\hat{w}}_{1 - 4}^{( t + 1 )} = ( 22.25 , 17.75 , 13.5 , 8. ) ,$$

and a sum thereof is 61.50.

Next, according to mathematical expression 2, a final weight of the document search-type expert 222-1 may be calculated as

$${w}_{1}^{( t + 1 )} = \frac{22.25}{61.5} = 0.3626 ,$$

and total final weights may be determined as

$${w}_{1 - 4}^{( t + 1 )} = ( 0.3626 , 0.2886 , 0.2195 , 0.1301 ) .$$

In other words, regarding the query analysis data containing the keyword [operating rate] described as the example above, the gating network 221 may give a higher weight to the document search-type expert 222-1 and select the document search-type expert 222-1 first, so as to provide an answer to the user through the expert. Thereafter, when the answer is not at the level wanted by the user, an answer by another expert may be provided again and the user reflection coefficients may be adjusted.

Further, in order to more precisely select at least one of the experts 222-n selected based on the query analysis data, the gating network 221 may perform a procedure to dynamically adjust weights by combining the current weights and the user reflection coefficients.

Specifically, the gating network 221 calculates a correction parameter α according to the following Equation 3 based on the current weight

$$( {w}_{i}^{( t )} )$$

and the user reflection coefficient

$$( {r}_{i}^{( t )} ) .$$

$$α = \frac{MIN ( {r}_{i}^{( t )} )}{MAX ( {r}_{i}^{( t )} ) + ϵ} \qquad [ Equation 3 ]$$

Wherein, α has a real value greater than or equal to 0 and less than or equal to 1, and ε is a small amount of real number that does not make the denominator zero.

The α calculated through the Equation 3 determines the correction ratio by reflecting the difference between the existing weight and the new user reflection coefficient.

Thereafter, the provisional weight

$${\hat{w}}_{i}^{( t + 1 )}$$

is calculated according to the following Equation 4 by using the calculated α.

$${\hat{w}}_{i}^{( t + 1 )} = {( {w}_{i}^{( t )} )}^{α} \cdot {( {r}_{i}^{( t )} )}^{1 - α} \qquad [ Equation 4 ]$$

The provisional weight calculated in the above manner is the result obtained by reflecting and balancing the existing reliability and the latest user feedback of each expert, and then normalization is performed subject to the Equation 2, thereby outputting the final weight

$$( {w}_{i}^{( t + 1 )} ) .$$

For example, as the above-described example, when the initial weights are set to

$${w}_{i}^{( 0 )} = ( 0.25 , 0.25 , 0.25 , 0.25 )$$

for the experts (222-1 to 4), respectively, and the user reflection coefficients are collected as

$${r}_{i}^{( t )} = ( 89 , 71 , 54 , 32 )$$

thereafter, α becomes 32/89, which is approximately 0.3595.

The provisional weight for the document search expert-type 222-1 is calculated as

$${\hat{w}}_{1}^{( t + 1 )} = {( 0.25 )}^{0.3595} \cdot {( 89 )}^{0.3595} = 8.241 ,$$

based on Equation 4 using the value x, and accordingly, the total provisional weights are calculated as

$${\hat{w}}_{1 - 4}^{( t + 1 )} = ( 8.241 , 7.258 , 6.2 , 4.717 ) ,$$

and a sum thereof is 26.416.

Then, the final weight of the document search-type expert 222-1 may be calculated as

$${w}_{1}^{( t + 1 )} = \frac{8.241}{26.416} = 0.312$$

according to Equation 2, and the total final weights may be determined as

$${w}_{1 - 4}^{( t + 1 )} = ( 0.312 , 0.275 , 0.235 , 0.178 ) .$$

As seen from these calculation examples, it is the same in that the document search-type expert 222-1 is selected through the gating network 221, but the final weight of each expert is dynamically changed according to the user reflection coefficient.

Meanwhile, α may be set to a fixed value by the system administrator, and may serve to stabilize processing in the early stages of system operation when the user reflection coefficient has not been sufficiently accumulated. When α is 0, only the user reflection coefficient is reflected 100%; when α is 1, only the previous weight is reflected 100%; and when x is 0.5, the both wights are reflected at the same ratio.

The response data generated through the gating network 221 and the expert module 222 is provided to the user through the output unit 120 in the user terminal 100.

The output unit 120 may include a display device, a speaker, a vibration feedback module, an LED visual display device, or the like, and may selectively activate the appropriate output mechanism depending on the type and nature of the response.

For example, a simple data query response such as “The morning operating rate of Line 2 equipment is 85%” may be output to the display device in text form. Whereas, for the emergency alert query, voice guidance through the speaker and an LED flashing warning may be simultaneously provided such as “Line 2 equipment is malfunctioning”.

In addition, the output unit 120 may provide UI factors for user feedback input along with the response (for example, transmission about an input space together with “Is this answer useful?”), t this allows the user to directly indicate a satisfaction with the result or enter an additional request, and the user feedback input may be implemented through the input unit 110.

Further, the user feedback is transmitted to the main server 200 via the network N through the user terminal 100. The transmitted user feedback is stored in the database 230 within the main server 200 and then used by the learning unit 250 for subsequent learning and system improvement.

The learning unit 250 functions to retrain some parameters of the language model processing unit 210 and the MoE architecture 220 based on user feedback data stored in the database 230.

More particularly, the learning unit 250 functions to retrain (fine-tune) even the query analysis capability of the language model processing unit 210 based on the result feedback collected from the user, and improves the language model processing unit 210 through the following procedure.

1. When a query interpretation error or a keyword extraction error is identified during user feedback, a type and a cause of the error are classified.

2. An additional learning dataset is created based on error cases, and a natural language processing algorithm of the language model processing unit 210 is corrected.

3. The adaptability and accuracy of the system are continuously improved by reflecting added entity names such as manufacturing site-specific vocabulary, new words, and new equipment names into the language model processing unit 210.

In addition, the learning unit 250 may analyze the result feedback provided by the user and update the selection weight, the user reflection coefficient, the response quality related parameter and the like for each expert 222-n in the expert module 222.

In addition, the language model processing unit 210 may perform retraining of the natural language processing model to improve query analysis accuracy, and may also add and modify scenario patterns for handling new query types.

For example, when negative feedback continues to be collected regarding responses of a specific expert 222-2, the learning unit 250 may reduce a selection weight of the expert or re-adjust a query type classification model, thereby dynamically optimizing the system so as to select more suitable experts.

The learning unit 250 may perform the above retraining process periodically or conditionally, and the retraining cycle, learning data size, update threshold and the like are controlled based on setting values stored in the memory device 240.

Thus, according to the system of the aspect of the present disclosure, the actual usage environment and feedback of the user may be applied, so that the question-and-answer service more optimized for the characteristics of manufacturing sites may be continuously provided, and further, the accuracy of semantic interpretation of user queries may be continuously improved in addition to simply optimizing expert selection.

To summarize, the aspect of the present disclosure provides the language model question-and-answer system based on a mixture of experts (MoE) architecture so as to support efficient question-and-answer and equipment data utilization by workers in manufacturing sites.

The query entered through the user terminal is analyzed and structured into semantic units by the language model processing unit, and then one or more experts are selected from a plurality of experts suitable for the query characteristics through the MoE architecture. The natural language response generated by the selected expert is output back to the user terminal, and user feedback thereof is used for continuously retraining the system and improving the performance.

In addition, the system of the aspect of the present disclosure separately operates the database for storing and managing manufacturing facility-related information, query history, user feedback data and the like, and the memory device for storing commands and parameters for processing and learning queries, so that external information management and internal algorithm optimization are simultaneously realized. In addition, the dynamic weight adjustment and the correction parameter calculation mechanism via the gating network are used, so that the flexible and accurate response processing according to various inquiry types and site situations may be provided.

The description of the disclosed embodiments is provided to enable those skilled in the art to use or practice the present disclosure. Various modifications to these embodiments will be readily apparent to those skilled in the art, and the generic principles defined herein may be applied to other embodiments without departing from the scope of the present disclosure. Therefore, the aspect of the present disclosure will not be limited to the embodiments set forth herein but will be construed in the broadest scope consistent with the principles and novel features set forth herein.

What is claimed is:

1. An MoE architecture-applied language model-based question-and-answer system for a manufacturing site, the system comprising:
a user terminal serving as a terminal of a worker in the manufacturing site;
a main server including a central processing unit; and
a network for relaying the user terminal and the main server, wherein
the user terminal comprises:
an input unit for receiving a query and user feedback in a voice or text form from a user; and
an output unit for outputting an answer to the user, and
the main server comprises:
an MOE architecture including an expert module composed of a plurality of experts, and a gating network for selecting one of the experts based on a type of the query;
a language model processing unit for analyzing the received query and generating a natural language-based answer through the expert selected by the gating network;
a database for storing manufacturing facility-related information, query history, and user feedback data; and
a memory device for storing commands and learning parameters for operations of the gating network and the language model processing unit.

2. The system of claim 1, further comprising:
a learning unit for retraining the language model processing unit based on the user feedback received from the user terminal.

3. The system of claim 1, wherein the expert module includes a retrieval-augmented generation (RAG)-based document search-type expert, a manufacturing facility DB query-based monitoring expert, a scenario response expert, and a general query expert.

4. The system of claim 1, wherein the gating network calculates a provisional weight
$$( {\hat{w}}_{i}^{( t + 1 )} )$$
according to Equation 1, and calculates a final weight
$$( {w}_{i}^{( t + 1 )} )$$
according to Equation 2, based on a current weight
$$( {w}_{i}^{( t )} )$$
for each expert and a user reflection coefficient
$$( {r}_{i}^{( t )} )$$
for the user feedback or selection frequency of the expert, so as to select one of the experts (wherein, subscript denotes an index to identify a specific expert; t denotes a time interval for weight update; and
$${\sum }_{j = 1}^{k}$$
denotes a sum of weights for all present experts from 1 to k).
$${\hat{w}}_{i}^{( t + 1 )} = {w}_{i}^{( t )} \cdot {r}_{i}^{( t )} \qquad [ Equation 1 ]$$
$${w}_{i}^{( t + 1 )} = \frac{{\hat{w}}_{i}^{( t + 1 )}}{{\sum }_{j = 1}^{k} {\hat{w}}_{i}^{( t + 1 )}} \qquad [ Equation 2 ]$$

5. The system of claim 4, wherein the gating network calculates a correction parameter α according to Equation 3 based on the current weight
$$( {w}_{i}^{( t )} )$$
and the user reflection coefficient
$$( {r}_{i}^{( t )} ) ,$$
calculates a provisional weight
$$( {\hat{w}}_{i}^{( t + 1 )} )$$
according to Equation 4 through the correction parameter α, and calculates a final weight
$$( {w}_{i}^{( t + 1 )} )$$
according to Equation 2, so as to select one of the experts (wherein, α has a real value greater than or equal to 0 and less than or equal to 1; and ε is a small amount of real number that does not make the denominator zero).
$$α = \frac{MIN ( {r}_{i}^{( t )} )}{MAX ( {r}_{i}^{( t )} ) + ϵ} \qquad [ Equation 3 ]$$
$${\hat{w}}_{i}^{( t + 1 )} = {( {w}_{i}^{( t )} )}^{α} \cdot {( {r}_{i}^{( t )} )}^{1 - α} \qquad [ Equation 4 ]$$
